(19) United States
(12) Patent Application Publication
(10) Pub. No.: US 2024/0005421 A1
(43) Pub. Date: Jan. 4, 2024

(54) Ancillary Management System for Providing Customized Booking Solutions

(71) Applicant: iSeatz, New Orleans, LA (US)

(72) Inventors: Bryan ESTEP, New Orleans, LA (US); Dominique Saulet, New Orleans, LA (US); Rebecca Jostes, New Orleans, LA (US)

(73) Assignee: iSeatz, New Orleans, LA (US)

(21) Appl. No.: 18/369,577

(22) Filed: Sep. 18, 2023

Related U.S. Application Data
(63) Continuation of application No. 17/553,595, filed on Dec. 16, 2021, now abandoned.
Application No. 17/553,595 is a continuation of application No. 16/564,138, filed on Sep. 9, 2019, now abandoned.
(60) Provisional application No. 62/773,781, filed on Nov. 30, 2018.
(60) Provisional application No. 62/728,283, filed on Sep. 7, 2018.

(51) Int. Cl. G06Q 50/14; G06Q 10/02

(52) U.S. Cl. CPC G06Q 50/14; G06Q 10/02

(57) ABSTRACT

A method of using a computerized booking platform disposed in communication with a partner administration interface is provided, the method including using the partner administration interface to store, access, integrate and output data and other information regarding a plurality of desired product offerings available on the booking platform. A method of integrating ancillary inventory and pricing systems is also provided, wherein the method includes disposing a computerized booking platform in communication with a partner administration interface, said method further including using the booking platform to interface with an internal ancillary inventory and pricing system in order to store, access, integrate and output data and other information regarding a plurality of desired product offerings.

### CROSS-REFERENCES TO RELATED APPLICATIONS

This patent application claims benefit of U.S. patent application Ser. No. 17/553,595, filed Dec. 16, 2021, which claims benefit of U.S. patent application Ser. No. 16/564,138, filed Sep. 9, 2019, which claims benefit of U.S. Provisional Patent Application No. 62/773,781, filed Nov. 30, 2018, which claims the benefit of U.S. Provisional Patent Application No. 62/728,283, filed Sep. 7, 2018, the contents of which are hereby incorporated by reference in their entirety.

### TECHNICAL FIELD

The present invention relates generally to computer-enabled business plans for managing ancillary product and service lines, and in a particular though non-limiting embodiment to a software solution comprising an ancillary management system (or “AMS”) that digitally manages ancillary products for travel companies. The invention also relates to a platform development offering that allows clients to partner in the creative development stage, and thereby acquire a flexible, reliable, precisely matched, fully branded solution without the burdensome time and cost investment previously known in the industry.

### BACKGROUND

Many e-commerce sites—offer customized solutions for clients trying to drive their products and brands into the public consciousness. Search engine optimization, cross-trade product placement, targeted reward programs, and many other modalities are already present in the market, but all generally suffer from the common draw-back of requiring design and implementation from the ground up.

The development and implementation process necessarily requires time, money and effort to visualize and implement a software solution; to create and integrate branded graphics and animation; to associate the data bases needed to populate the many variable entry fields; to debug the finally integrated solution; and to then maintain the final product over time, which can itself be a time- and money-consuming exercise since each such package is custom built and therefore by definition unlike any other solution created by the platform developer.

Ancillary products are defined as products that are supplemental to a core product offering. The product may or may not originate from an internal or external source as compared to the seller/distributor's core offering. Examples of an internal ancillary product might comprise a round of golf or a spa treatment at a resort being offered in addition to a room or other lodging. An example of external ancillary might comprise a city tour offered by a third-party vendor through a hotel front desk or hotel website.

### BRIEF DESCRIPTION OF THE DRAWING

FIG. 1 is a flow chart illustrating a first aspect of the present invention.

FIG. 2 is a flow chart illustrating a second aspect of the present invention.

### SUMMARY

A method of using a computerized booking platform disposed in communication with a partner administration interface is provided, the method including using the partner administration interface to store, access, integrate and output data and other information regarding a plurality of desired product offerings available on the booking platform. A method of integrating ancillary inventory and pricing systems is also provided, wherein the method includes disposing a computerized booking platform in communication with a partner administration interface, said method further including using the booking platform to interface with an internal ancillary inventory and pricing system in order to store, access, integrate and output data and other information regarding a plurality of desired product offerings.

### DETAILED EXAMPLES OF SEVERAL REPRESENTATIVE EMBODIMENTS

The present invention offers client partners a single integrated, holistic, reliable solution set from which a plurality of previously created and tested tools, managed services and components allow the partner to leverage their businesses using precisely matched, fully branded solutions without the time and cost investment of creating each such solution from scratch as is typically the case in the industry today.

Since the ultimate solution all originates from a common booking platform provider, safety, reliability and seamless integration across the platform are ensured. Moreover, since new features, system improvements, vulnerability upgrades, bug fixes and more are constantly evolving, this centralized booking platform delivery architecture easily outpaces the quality and flexibility suggested anywhere in the prior art. Once a client partner is running on the provider platform, the client partner can create, customize, update and present their solution in a great many ways, emphasizing the widely variable aspects of their solution as desired.

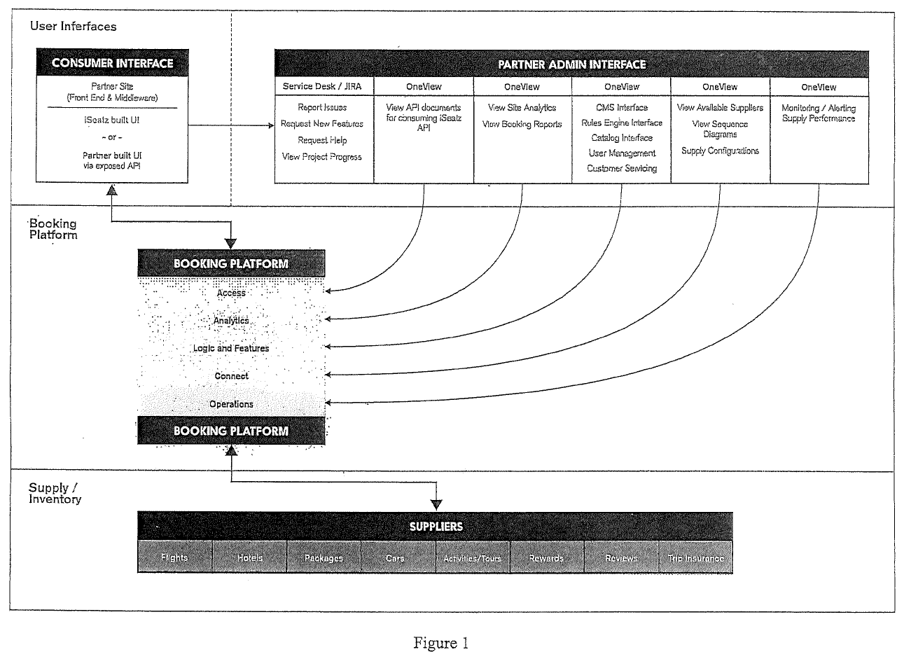

With reference to FIG. 1, those of ordinary skill in the art will appreciate that the engine of the invention is essentially a booking platform. The booking platform provider offers one or more of a plurality of custom tools and information, as well as third-party tools and information either licensed by the booking platform provider or provided either directly or indirectly by the third parties. In the example depicted in FIG. 1, the booking platform network creates and protects access, offers analytics, controls the system logic and available features, and 20 enables and defines connectivity and operations so that supplier production and information are variably and scalably offered to client partners, which, using a client partner interface, then creates the final outward-looking platform ultimately interfaced by consumers over the internet or another suitable product booking service.

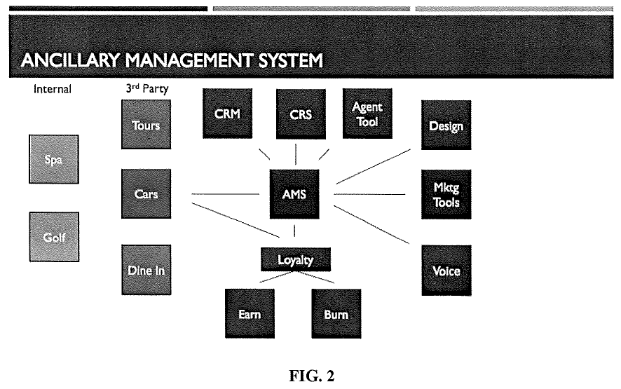

Ordinarily skilled artisans will appreciate that the definitions, concepts and connection and data transfer paths depicted in FIGS. 1 and 2 are illustrative in nature only, and are not intended to limit the scope or spirit of the instant disclosure in any way.

For example, while the booking platform features in FIG. 1 might be appropriate for certain client partners, far more robust offerings are certainly contemplated as well. In one example embodiment, the booking platform also comprises methods and means (for example, a computer) for storing accessing, integrating and outputting data and other information regarding one or more of a product API (i.e., an application programming interface, essentially a set of subroutine definitions, protocols, and tools for building software); client, vendor and consumer name records; booking, processing, verification and reporting services; existing supplier connections; product aggregation data; customized partner connections; content management; email services; notification services; localization services; point of sale configurations; external system synchronization; loyalty support; reward program management; agent booking and servicing support; a rules engine; and advanced analytics and system reporting.

In one detailed but non-limiting embodiment, the booking platform comprises what is essentially a flexible, reliable, customizable content and inventory aggregation engine appropriate for virtually any field of endeavor. In another, still more detailed but non-limiting embodiment, the relevant fields of endeavor further comprise one or more of the travel, hospitality and finance industries.

Returning now to FIG. 1, it is seen that in the example embodiment, the booking platform offering suite is, at least to some degree, populated by supplier content. Such content may be the booking platform provider's own content, or third-party content obtained from other sources. In the depicted example, the supplier content offerings originate from many different fields of endeavor, for example, for the airline industry example, from the airline industry, hotel industry; package delivery industry; automobile industry; activity and tour industry; rewards programs; reviews obtained from potentially myriad sources; and the trip insurance industry. As with the booking platform discussed above, ordinarily skilled artisans will appreciate that the depicted menu of supplier options in arbitrary, and can in practice comprise many other options, and as many or few in number as desired by the booking platform provider.

There is no definitive architecture required for the communication protocol between the supplier information and the booking platform, but since this aspect is the “back room” portion of the booking platform provider system, much of the information can be stored and provided to the booking platform via direct entry, data pulled from data bases and look up tables or the like, or in any other manner presently known or future devised that permits transmission and retention of the supplier information to the booking platform.

A key aspect of the invention is the interaction between the booking platform and the client partner administration interface (or PAI). In the depicted example, the PAI has several features, some of which are discrete and relate to the client partner's business particulars, and a plurality of interactive interface controls used to search, query, select, adjust, change and build booking platform offerings into the ultimate front-end consumer interface (whether a web site, an app, a social media connection, etc.) with the look and feel desired by the client partner for offering its goods or services to targeted consumers.

For example, in the detailed though non-limiting embodiment depicted in FIG. 1, the PAI comprises a service desk type feature, which enables the partner to report issues to the booking platform provider, request new features or deletion of old features, request help and to view project progress. Ordinarily skilled artisans will of course appreciate that a great many other features and modalities can be included in this aspect of the PAI.

Similarly, a PAI tool depicted as communicating directly or indirectly with the access feature of the booking platform enables the client partner to view API documents for consuming booking platform provider API. Another PAI tool communicating either directly or indirectly with the analytics feature of the booking platform enables the client partner to view site analytics and booking reports. Yet another PAI tool communicating either directly or indirectly with the logic and features feature of the booking platform enables client partners to access the PAI content management system, rules engine, catalog, user management tools and customer service features. A further PAI tool communicating either directly or indirectly with the booking platform's connections feature enables client partners to view available suppliers, sequence diagrams, and supply configurations. Finally, a still further PAI tool communicating either directly or indirectly with the booking platform's operations feature enables client partners to monitor and alert supply performance.

As with the other aspects of the instant disclosure, ordinarily skilled artisans will readily appreciate that the depicted PAI is illustrative in nature only, and is not intended to definitively require all or even any of the PAI tools disclosed herein, as each may be supplemented, amended, simplified or made more granular by the client partner depending on the partner's business needs. Likewise, PAI communication paths to and from the booking platform are also arbitrary, and may in practice be carried out in any manner currently known or future devised so long as mutual communication between the PAI, booking platform, and supplier information is satisfactory for its intended purposes.

Finally, after the client partner has queried and defined the supplier goods and services and interface particulars desired for presentation to the end user, all such data is aggregated into a single, robust, aesthetically pleasing business engine made available via website, app, social media, etc., in a secure but flexible environment created on a time- and cost-effective basis. The end user or consumer is then presented with an interface containing only the content and tools desired and selected by the client partner. Options in this respect are virtually limitless, as the client partner may (or may not) wish to change colors, branding indicia, financial or security protocols, add automatic updates, and so on, in order to provide the precise consumer interface desired by the client partner.

Another object of the solution described herein is to unify a plurality of disparate yet unique and overlapping software solutions; to manage inventory and pricing; to define and enhance associated branding; to merchandize, cross-promote, and market; to distribute via multiple channels including digital, voice technology, television/video, as well any future distribution technologies not yet devised; to offer segment messaging, offers, and other communications to unique user groups or individual profiles; to leverage loyalty programs through point earning, redemption, and/or any other complementary loyalty exchanges; to offer curation; and to provide variable and scalable digital design and an associated analytics dashboard.

According to one specific but non-limiting embodiment, primary software-enabled integrations comprise internal ancillary inventory and pricing systems; external ancillary inventory and pricing systems; Central Reservations Systems (CRS); Property Management Systems (PMS); Customer Relationship Management (CRM) and other user profile systems; Customer Loyalty systems; design software; analytics software; marketing software; distribution applications such as internet, television, and voice software; and other digital web integrations such as vendor/distributor websites. The integrations further comprise future technology not yet reduced to practice. Integrations typically occur via application protocol interfacing, or API.

Internal Ancillary Inventory & Pricing Systems

In one example embodiment, and with reference now to accompanying FIG. 2, the AMS integrates with systems that manage internal ancillary pricing and inventory of products or services created and/or owned by the user. In various embodiments, such systems originate from the user's own development, or from a third party vendor. Examples of internal ancillary inventory comprise one or more of a plurality of such services, e.g., spa services, golfing, room extras such as welcoming champagne and fruit or the like, club floors, gym usages, and/or seminars. For airlines, such services comprise extras such as seat upgrades, meals, club entry for airlines, etc. In short, internal ancillary inventory and pricing systems that manage goods and services either owned and/or offered by the user regardless of whether the system was internally-created or created through a third party.

External Ancillaries Inventory & Pricing Systems

According to various other embodiments, the AMS integrates with systems managing external ancillary pricing and inventory of products and/or services created and/or sourced by third parties. Examples of ancillary inventory for airlines, hotels, car rental, financial services companies and other travel companies comprise one or more of a plurality of such services, such as tours, activities, car rental, dining reservations, dining delivery, and/or ground transportation, as offered directly by third-party suppliers or consolidators. Exceptions comprise products considered core to a primary business model, such as rental cars for a rental car company.

Central Reservations Systems

In further embodiments, the AMS integrates with a Central Reservations System (CRS), whether provided by a third party or developed by a user itself. Example data flows from the CRS to AMS include customer names and unique IDs, such as loyalty or reservations numbers. In this example embodiment, data flow from the AMS to the CRS comprises a plurality of details related to ancillary bookings, whether consolidated or in parts, including product type, date, time, duration, location, units purchased, and/or policies; as well as a master booking record formatted for customer and user staff access.

Customer Relationship Management or User Profile System

In yet another embodiment, the AMS integrates with a Customer Relationship Management (CRM) system and/or User Profile system, whether provided by a third party or developed by the user itself. In this embodiment, example data flow from the CRM to the AMS comprises customer names and unique IDs, such as loyalty or reservations numbers, and may further comprise customer activity histories used to facilitate segmented and personalized offers of ancillaries. In this example embodiment, data flow from the AMS to the CRM includes all details related to ancillary bookings whether consolidated or in parts including product type, date, time, duration, location, units purchased, policies; and/or a master booking record formatted for customer relationship management.

Property Management System

In a further embodiment still, the AMS integrates with a Property Management System (PMS) system and/or a User Profile system, whether provided by a third party or developed by the user itself. In this example embodiment, data flow from the PMS to the AMS comprises customer names and unique IDs, such as loyalty and/or reservations numbers. In other embodiments data flow from the AMS to the CRS comprises details related to ancillary bookings, whether consolidated or in parts, further comprising product type, date, time, duration, location, units purchased, related policies; and/or master booking record formatted for customer and user staff access.

Customer Loyalty System

In other embodiments, the AMS integrates with a Customer Loyalty System, whether provided by a third party or developed by the user itself. In this example embodiment, data flow from the Customer Loyalty systems to the AMS comprises conversion rates used to translate from a designated base currency to associated loyalty point denominations and vice versa. In further embodiments, data flow from the AMS to the Customer Loyalty Systems comprises unique customer account identifiers, and in a further embodiment still with a number of loyalty points that can be used to credit to, or debit from, the designated customer account.

Design Software

In yet another embodiment the AMS integrates with third party Design Software. Functionality from the Design Software systems to the AMS comprises the ability To leverage a design platform as a plurality of service tools used to design a user experience and/or user interface for end consumers branded with the distributor's brand. In further embodiments, the integration also includes the ability to provide a Content Management System either through a third party or created by a proprietor for the user or distributor to make changes to the web interface as desired. The resultant is internal and external ancillaries offered via a digital experience to end consumers with the user and/or distributor designs and brands if preferred.

Marketing Software

In another embodiment the AMS integrates with a marketing software system, whether provided by a third party or a platform proprietor or distributor. The example integration comprises one or more of a plurality of such ancillaries such as A/B testing, e-mail templating and distribution, e-mail lists, landing pages, lead nurturing, lead scoring, search marketing, segmentation, social marketing, visitor tracking, and/or dynamic content used to promote and merchandize ancillaries.

Reporting Dashboard

In yet another embodiment the AMS integrates data from a wide variety of sources, and consolidates and presents the data in an AMS reporting dashboard. In this example embodiment, sources comprise, but are not limited to, third party and internal ancillary booking dates, times, passenger names, products, services, pricing, margins, booking window, lead source, funnel and conversion activity, location, and/or cross-referencing of data to identify trends.

Agency Tools

In a further embodiment the AMS integrates with a provider or distributors own agency tools and/or third party tools to enable agents to track, book, modify, and cancel reservations.

Voice Software

In a further embodiment the AMS integrates with voice software to dynamically offer, promote, and position internal and third party ancillaries.

Television and/or Video

In a still further embodiment the AMS integrates with voice software to dynamically offer, promote, and position internal and third party ancillaries.

The foregoing specification is provided only for illustrative purposes, and is not intended to describe all possible aspects of the present invention. While the invention has herein been shown and described in detail with respect to several exemplary embodiments, those of ordinary skill in the art will appreciate that minor changes to the description, and various other modifications, omissions and additions may also be made without departing from the spirit or scope thereof.

1. A method comprising using a computerized booking platform disposed in communication with a partner administration interface, said method further comprising:
using said partner administration interface to store, access, integrate and output data and other information regarding a plurality of desired product offerings available on said booking platform.

2. The method of claim 1, further comprising using said partner administration interface to store, access, integrate and output data and other information regarding a plurality of discrete- and related client partner business particulars.

3. The method of claim 1, further comprising using said partner administration interface to interface with a plurality of interactive interface controls used to search, query, select, adjust, change and build booking platform offerings into an ultimate front-end consumer interface.

4. The method of claim 1, further comprising using said partner administration interface to interface with a service desk type feature enabling a partner to report issues to a booking platform provider, request new features or deletion of old features, request help and to view project progress.

5. The method of claim 1, further comprising communicating either directly or indirectly with an access feature of the booking platform, thereby enabling a client partner to view associated booking platform documents.

6. The method of claim 1, further comprising communicating either directly or indirectly with an analytics feature of the booking platform, thereby enabling the client partner to view site analytics and booking reports.

7. The method of claim 1, further comprising communicating either directly or indirectly with various logic and features of the booking platform, thereby enabling client partners to access—one or more of a content management system, a rules engine, a catalog, various user management tools, and various customer service features.

8. The method of claim 1, further comprising communicating either directly or indirectly with a booking platform connections feature, thereby enabling client partners to view one or more of available suppliers, sequence diagrams, and supply configurations.

9. The method of claim 1, further comprising communicating either directly or indirectly with a booking platform operations feature, thereby enabling client partners to monitor and alert supply performance.

10. A method of integrating ancillary inventory and pricing systems, wherein said method comprises disposing a computerized booking platform in communication with a partner administration interface, said method further comprising:
Using said booking platform to interface with an internal ancillary inventory and pricing system in order to store, access, integrate and output data and other information regarding a plurality of desired product offerings.

11. The method of claim 10, further comprising using said booking platform to interface with one or more external ancillary inventory and pricing systems in order to store, access, integrate and output data and other information regarding a plurality of desired product offerings.

12. The method of claim 10, further comprising using said booking platform to interface with one or more central reservation systems.

13. The method of claim 10, further comprising using said booking platform to interface with one or more property management systems.

14. The method of claim 10, further comprising using said booking platform to interface with one or more customer relationship management profile systems.

15. The method of claim 10, further comprising using said booking platform to interface with one or more customer loyalty systems.

16. The method of claim 10, further comprising using said booking platform to interface with one or more software packages, where said one or more software packages further comprises one or more of a design software package, an analytics software package, and a marketing software package.

17. The method of claim 10, further comprising using said booking platform to interface with one or more distribution applications, wherein said distribution applications further comprise one or more of an internet software package a television software package, and a voice software package.

18. The method of claim 10, further comprising using said booking platform to interface with one or more digital web integrations, wherein said digital web integrations further comprise one or more of a vendor website and a distributor website.
